(19) United States
(12) Patent Application Publication
(10) Pub. No.: US 2005/0025181 A1
(43) Pub. Date: Feb. 3, 2005

(54) Service advisor

(76) Inventor: Ala Nazari, Stockholm (SE)

Correspondence Address: SQUIRE, SANDERS & DEMPSEY L.L.P.;Two Renaissance Square, 40 North Central Avenue, Suite 2700, Phoenix, AZ, 85004-4498, US

(21) Appl. No.: 10/838,500

(22) Filed: May 3, 2004

Related U.S. Application Data
(60) Provisional application No. 60/467,427, filed on May 2, 2003.

(51) Int. Cl. H04B 7/00

(52) U.S. Cl. 370/469

(57) ABSTRACT

A service advisor detects the availability of a wireless communication service, communication being consistent with one or more protocols (e.g., IEEE 802.11 MAC layer) each having a plurality of packet formats. The service advisor includes an interface, a receiver, and an engine. The interface couples the service advisor to a provided consumer electronics product-(e.g., a cell phone or personal digital assistant (PDA)) having an annunciator (e.g., a display, speaker, or vibrator). The receiver receives communication by scanning a plurality of channels. The engine, coupled to the receiver and to the product via the interface, recognizes in response to the communication, only a limited set of packet formats of the plurality of formats; determines, from a packet having a format of the set, indicia of an available service; and facilitates operation of the annunciator in accordance with the indicia of available service. Use of the available service by the product involves recognizing a packet format not included in the set. In one implementation, the provided product includes a transmitter for use of the available service. Power consumption by the product may be reduced when desired communication services are not available. Another service advisor discovers services for purposes of horizontal and vertical handover.

### CROSS-REFERENCE TO RELATED APPLICATIONS

This application claims priority to U.S. Provisional patent application Ser. No. 60/467,427 by Ali Nazari, filed May 2, 2003, incorporated herein by this reference.

### FIELD OF THE INVENTION

Embodiments of the present invention relate to wireless communication.

### BACKGROUND OF THE INVENTION

Conventional wireless communication uses radio frequencies or infrared light for signals between communicating devices. Communication may be point to point to form a link. Multiple links may be organized to form a network. Networks may be formed among mobile devices (e.g., ad hoc networks, peer-to-peer communication) or formed with both mobile and fixed devices. Fixed devices (also called access points (APs)) may be coupled to a local area network (LAN) to form an infrastructure network with mobile devices. Communication generally conforms to standards such as IEEE 802.11 which specify operation of ad hoc networks (e.g., one or more links) and infrastructure networks (also called wireless local area networks (WLANs). Operation includes communication according to layers of protocols (also called protocol stacks) including at least one physical protocol, media access control (MAC) layer protocol, and upper level protocols (e.g., TCP/IP, H.323). Devices that are capable of operating with a link or a network generally include a processor circuit programmed to support all functions of a protocol stack, and a transmitter.

Further deployment of devices capable of operating with a link or a network is impeded by relatively high power consumption by the processor circuit and transmitter of the device. Typically, the processor circuit and transmitter are active, consuming power, even when no link or network is available for communication.

WLAN technologies are gaining popularity because communication is in the unlicensed Industrial Scientific and Medical (ISM) band (e.g., from 2.40 GHz to 2.484 GHz, or from 5.725 GHz to 5.85 GHz) where communication is relatively inexpensive. However, threats to the global success of WLAN technologies include: (a) the possibility that widespread user demand will exceed the practical supply of efficient services; (b) the possibility that APs will be widely deployed without solving security and availability issues; (c) the cumbersome process of determining whether an AP is available for communication (e.g., detection and/or discovery); and (d) limited deployment of roaming support, fair billing procedures, and attractive services.

Conventional WLAN stations (STAs) are fully operational before being able to detect or discover access points or other stations. If an AP is detected or discovered, connectivity may be unavailable (e.g., the AP operator may require the user or station to have subscribed to a service), consequently no link is formed. If an AP is discovered to be available, local physical obstacles may from time to time impede communication. In a conventional WLAN station, after a link is established on one channel, the station is unable to monitor other channels, for example, for choosing a better channel.

Systems according to various aspects of the present invention, among other things, address the drawbacks discussed above, particularly those associated with detection and discovery, helping the user become aware of the availability of a suitable AP. Peer and/or AP detection and/or discovery may facilitate more widespread use of a WLAN for services provided (e.g., for profit) by a WLAN operator.

Without peer and/or AP detection and/or discovery, a prohibition against use of radio transmitters is difficult to enforce. Communication may be desired to be restricted to reduce the risk of interference with sensitive equipment as in hospitals and airplanes, or for other reasons imposed by site administrators (e.g., secure installations). For instance, it is difficult to enforce a prohibition on an airplane where two passengers may be playing computer games over a radio link without radio transmitter detection targeting point-to-point links.

### SUMMARY OF THE INVENTION

A communication device, according to various aspects of the present invention includes a service advisor and an application engine. The service advisor discovers services. The service advisor has a receiver. The application engine has a transceiver. The service advisor and the application engine cooperate for operation of the receiver without interfering with the transceiver.

A service advisor in one implementation according to various aspects of the present invention, provides notice regarding the availability of a wireless communication service. The communication service may be usable by a communication device not coupled to the service advisor. Communication is consistent with one or more protocols each having a plurality of packet formats. The service advisor may include a receiver and an engine. The receiver receives communication. The engine, coupled to the receiver, recognizes in response to the communication, a limited set of packet formats of the plurality of formats; determines, from a packet having a format of the set, indicia of an available service; and facilitates operation of a provided annunciator to provide notice in accordance with the indicia of available service, wherein the use of the available service by the communication device involves recognizing a packet format not included in the set.

By providing notice to a user, the user may then initiate operation of the communication device to use the available service. Until notice is received, operation of a processor for communication according to a comprehensive protocol stack and operation of a transmitter may be avoided, conserving power. Without operation of the transmitter, congestion of communication channels may be reduced.

The service advisor discussed above may be implemented in a pocket sized package and may have diverse function (e.g., a key chain or pen). The annunciator may provide sound or vibration to attract the user's attention.

A service advisor in another implementation according to various aspects of the present invention, detects the availability of a wireless communication service, communication being consistent with one or more protocols each having a plurality of packet formats. The service advisor includes an interface, a receiver, and an engine. The interface couples the service advisor to a provided consumer electronics product. The receiver receives communication. The engine, coupled to the receiver and to the product via the interface, recognizes in response to the communication, a limited set of packet formats of the plurality of formats; determines, from a packet having a format of the set, indicia of an available service. In one implementation the engine facilitates operation of an annunciator in accordance with the indicia of available service. Use of the available service by the product involves recognizing a packet format not included in the set. In another implementation, the provided product includes a transmitter for use of the available service. In yet another implementation, the engine facilitates performance of a horizontal or vertical handover by the product.

By detecting the availability of a wireless service for use by the product, power consumption by the product may be reduced or avoided when the wireless service is not available.

### BRIEF DESCRIPTION OF THE DRAWING

Embodiments of the present invention may now be further described with reference to the drawing, wherein like designations denote like elements, and:

FIG. 1 is a functional block diagram illustrating operational relationships between a service advisor other terminals, links, and networks according to various aspects of the present invention;

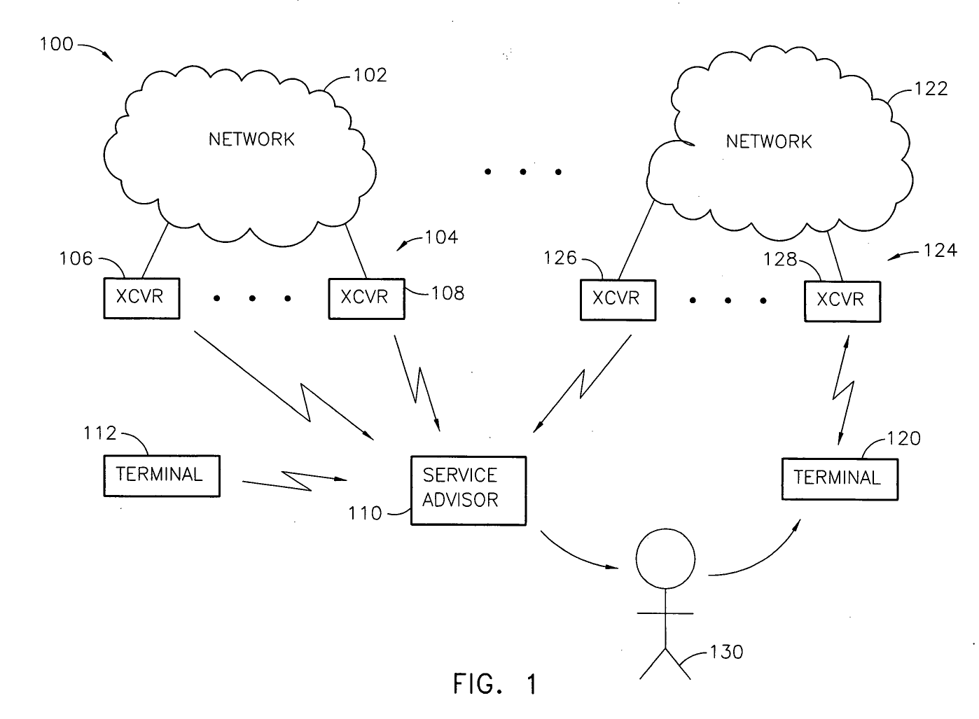

FIG. 2 is a functional block diagram of a service advisor of FIG. 1 in a first exemplary implementation;

FIG. 3 is a functional block diagram of a service advisor of FIG. 1 in a second implementation;

FIG. 4 is a functional block diagram of a service advisor of FIG. 1 in a third implementation;

FIG. 5 is a functional block diagram of a service advisor of FIG. 1 in a fourth implementation;

FIG. 6 is a functional block diagram of a portion of the receiver of FIG. 1;

FIG. 7 is a functional block diagram of a digital portion of the receiver of FIG. 1; and

FIG. 8 is a functional block diagram of a service advisor apparatus according to various aspects of the present invention.

### DETAILED DESCRIPTION OF THE PREFERRED EMBODIMENTS

A service advisor according to various aspects of the present invention determines the availability of a service on one or more communication media (e.g., frequency bands, modulations, and protocols). In operation, a service advisor monitors and takes some action on the results of monitoring. Monitoring includes receiving communication and analyzing received communication to determine whether a service is available or not. Successful monitoring may be referred to as discovery in as much as a service that has been determined to be available is considered to have been discovered by the service advisor. Analysis may include whether received communication indicates that a transmitter with desired characteristics exists. Analysis may include ascertaining whether indicia of the received communication are within suitable ranges (e.g., match) particular parametric values stored in the service advisor (or accessible to the service advisor). Actions may include: (a) reporting to a user or to a process; and/or (b) operating a control of a process.

A service advisor generally performs functions (e.g., receiving) that may to some extent correspond to a limited subset of the functions performed by a communication device intended to participate in the service being monitored (herein called a terminal). Because the purpose of a service advisor differs from the purpose of a terminal, functions that may correspond between a service advisor and a terminal are generally implemented more simply in the service advisor because the service advisor generally does not meet all terminal specifications of the service being monitored and consequently may be implemented with fewer components both hardware and software and with wider performance margins. These differences generally permit a service advisor to be implemented at a fraction of the cost and size of a terminal.

In one implementation, a service advisor determines whether a service of a wireless local area network is available (e.g., suitable connectivity). Actions taken when such a service is available include reporting to a user (e.g., providing an annunciation, such as a notice to a user) and/or facilitating a wireless local area network connection.

In another implementation, a service advisor cooperates with a terminal to facilitate vertical and/or horizontal handover of an operating link without user intervention. Handover may be horizontal or vertical, where horizontal handover is generally within the same access technology (e.g., between different cellular telephone carrier networks) and vertical handover is not within the same access technology (e.g., handing over a cellular voice connection to a VoIP service).

A service advisor may include functions for one or more access technologies. For clarity of description, a service advisor having only WLAN (Wireless Local Area Network) access technology capability (and specifically IEEE 802.11 a-g) is discussed below. In alternate service advisor implementations, other single services may be monitored or multiple (horizontal and vertical) services may be monitored.

A service advisor, according to various aspects of the present invention, may assist users of WLAN services to identify geographical areas within which they are served by access points or are reachable by WLAN transmitters for links or networks. These may be APs or WLAN stations (collectively called terminals). The service advisor may receive communication (e.g., scan) for particular WLAN bands (e.g. 2.4 GHz and 5 GHz) and may inform its user whenever a transmitting WLAN device (AP or other) is found that exhibits desired characteristics.

The following glossary of terminology and acronyms serves to assist the reader by providing a simplified quick-reference definition. A person of ordinary skill in the art may understand the terms as used herein according to general usage and definitions that appear in widely available standards and reference books.

3rd Generation (3G) partnership project (3GPP): A grouping of international standards bodies, operators and vendors with the responsibility of standardizing the WCDMA based members of the IMT-2000 family.

Access control: The prevention of unauthorized usage of resources.

Access point (AP): An entity that has station functionality and provides access to a distribution service via a wireless medium for associated stations.

Ad hoc network: A network composed solely of stations within mutual communication range of each other via the wireless medium. An ad hoc network is typically created in a spontaneous manner. An ad hoc network typically has a limited temporal and spatial extent. Creating and dissolving the conventional ad hoc network is relatively convenient so as to be achievable by non-technical users. Ad hoc may refer to an independent basic service set (IBSS).

Association: An association service may be used to establish access point and/or station mapping (e.g., a relationship called an association). An association service may enable a station to access a distribution system service (DSS).

Authentication: An authentication service may be used to establish the identity of one station as a member of the set of stations authorized to associate with another station.

Basic service area (BSA): An area (e.g., logical or physical) within which members of a basic service set (BSS) may communicate.

Basic service set (BSS): A set of stations controlled by a single coordination function.

Basic service set (BSS) basic rate set: A set of data transfer rates that all the stations in a BSS may be capable of using to receive frames from the wireless medium. These data rates may be preset for all stations in the BSS.

Broadcast address: A unique multicast address that specifies all stations.

Channel: An instance of medium use for the purpose of passing protocol data units that may be used simultaneously, in the same volume of space, with other instances of medium use (on other channels) by other instances of the same physical layer with an acceptably low frame error ratio for errors due to mutual interference. Some physical layers provide only one channel, whereas others provide multiple channels.

Coordination function pollable: A station able to: (a) respond to a coordination function poll with a data frame, if such a frame is queued and able to be generated; and (b) interpret acknowledgments in frames sent to or from the point coordinator.

Coordination function: The logical function that determines when a station operating within a basic service set is permitted to transmit and may be able to receive protocol data units via the wireless medium. The coordination function within a basic service set may have one point coordination function and may have one distributed coordination function.

De-authentication: A service that voids an existing authentication relationship.

Directed address: An address in a frame that specifies a single recipient, not a broadcast or multicast address.

Disassociation: A service that removes an existing association relationship.

Distributed coordination function (DCF): A class of coordination functions where the same coordination function logic is active in every station in the basic service set whenever the network is in operation.

Global system for mobile communications (GSM): A digital cellular phone technology based on TDMA that is the predominant system in Europe, but is also used around the world. GSM phones use a Subscriber Identity Module (SIM) smart card that contains user account information.

Independent Basic Service Set (IBSS): A BSS that forms a self-contained network, and in which no access to a controlling access point is available.

Infrastructure BSS: An infrastructure may include one or more access points and stations, typically fixed in location.

Medium access control (MAC) management protocol data unit (MMPDU): A unit of data exchanged between two peer MAC entities to implement the MAC management protocol.

Medium access control-(MAC) protocol data unit (MPDU): The unit of data exchanged between two peer MAC entities using the services of the physical layer.

Medium access control (MAC) service data unit (MSDU): Information that is delivered as units between MAC service access points (SAPs).

Mobile station: A type of station that uses network communications while in motion.

MPDU means a MAC protocol data unit.

Multicast: A medium access control (MAC) address that has the group bit set. A multicast MAC service data unit (MSDU) typically has a multicast destination address.

Network allocation vector (NAV): An indicator, maintained by each station, of time periods when transmission onto the wireless medium may not be initiated by the station whether or not the station's clear channel assessment function senses that the wireless medium is busy.

Protocol data unit (PDU): A unit of information transfer (e.g., a frame or packet).

PHY-SAP means physical layer service access point.

PIFS means point (coordination function) interframe space.

Public land mobile network (PLMN): Any cellular operator's network.

Point coordination function (PCF): A class of possible coordination functions in which the coordination function logic is active in only one station in a basic service set (BSS) at any given time that the network is in operation.

Portable station: A type of station that may be moved from location to location, but uses network communication while stationary.

Re-association: An association may be between an access point and a station. A re-association service enables an established association to be transferred from one AP to another AP. Transfer may be from one channel of an AP to another channel of the same AP.

SAP means service access point.

SIFS means short interframe space.

SME means station management entity.

Station (STA): Any device that includes an IEEE 802.11 conformant medium access control (MAC) and physical layer (PHY) interface to a wireless medium.

Station basic rate: A data transfer rate belonging to the extended service set (ESS) basic rate set that is used by a station for particular-transmissions. The station basic rate may change dynamically as frequently as each medium access control protocol data unit (MPDU) transmission attempt, based on local considerations at that station.

Station service (SS): The set of services that support transport of medium access control service data units (MSDUs) between stations within a basic service set.

Time unit (TU): A measurement of time equal to 1024 μs.

Um: The air interface between the BTS and the MS in a GSM network.

Universal mobile telecommunications system (UMTS): The European implementation of the 3G wireless phone system, which is part of IMT-2000, provides service in the 2 GHz band and offers global roaming and personalized features. Designed as an evolutionary system for GSM network operators, multimedia data rates up to 2 Mbps are expected using the WCDMA technology.

Universal terrestrial radio access (UTRA): the air interface component of WCDMA.

Universal terrestrial radio access network (UTRAN): The UMTS radio access network comprising the RNC, Node B, and the air interface.

Unicast frame: A frame that is addressed to a single recipient, not a broadcast or multicast frame.

Uu: The air interface between the Node B and the MS in a UMTS network.

Wideband CDMA (WCDMA): A 3G technology that increases data transmission rates in GSM systems by using the CDMA air interface instead of TDMA. In the ITU's IMT-2000 3G specification, WCDMA has become known as the Direct Sequence (DS) mode. WCDMA may use a frequency division duplex mode (FDD) or a time division duplex mode (TDD).

Wireless medium (WM): The medium used to implement the transfer of protocol data units between peer physical layer entities of a wireless local area network, for example a particular frequency band (e.g., radio or light channel), modulation, and protocols.

Communication as discussed herein may include sending and/or receiving according to any protocol or protocol stack (e.g., wireless personal area networks (WPAMs) such as Bluetooth and wireless local area networks (WLANs) such as IEEE 802.11, WCDMA, GSM, 3G wireless, and 4G wireless). The terms sending, receiving, and communicating may refer to more or less functionality in the context of the protocol being discussed. For example, sending at a lower protocol layer may include modulating and transmitting and at a higher layer protocol may include formatting and framing. Receiving at a lower protocol layer may include detecting and demodulating and at a higher layer protocol may include requesting retransmission until a message is received without error.

In the following discussion, communication presumes consistency with IEEE 802.11. IEEE 802.11 is a wireless LAN standard developed by an IEEE committee to specify an “over the air” interface between a wireless client and a base station or access point. One purpose of the standard is to facilitate rapid deployment of wireless connectivity to automatic machinery and equipment or stations (e.g., fixed, portable (handheld), and mobile). The IEEE 802.11 standard defines a physical layer protocol and a media access control protocol layer for a WLAN. A typical WLAN setup includes one or more Access Points (AP) connected with a Distribution system (DS). Each AP transmits (e.g., broadcasts) and receives wireless information in a Basic Service Set (BSS) area. Any stations in the BSS area that have suitable authority may communicate with the AP using the protocols defined by IEEE 802.11 (a)-(g). IEEE 802.11 supports two topologies: (a) infrastructure BSS for a network having some or all fixed nodes; and (b) independent BSS for an ad hoc network. The infrastructure basic service set (BSS) is a building block of an IEEE 802.11 LAN. For instance, an infrastructure BSS may have three stations and one access point. Each station may have a fixed location, be portable, or be mobile. Each station sends data to another station through the AP. Before sending data, each station must become a member of the infrastructure BSS. Membership exists when the station is “associated” as discussed above. The association between a station and a BSS may be dynamic to accommodate stations asynchronously and without notice turning on, turning off, coming within range, and going out of range. If a station moves out of its basic service area, it may no longer communicate with other members of the same BSS and AP.

A service advisor, according to various aspects of the present invention, assists a user (or a process performed by a terminal) to communicate via one or more suitable and/or desirable networks. For example, an environment 100 includes a network 102, a terminal 112, a service advisor 110, a terminal 1-20, and a network 122. Network 102 has a plurality 104 of transceivers. Network 122 has a plurality 124 of transceivers. Networks 102 and 122 as well as transceivers 104, transceivers 124, and terminals 112 and 120 may be conventional. In the illustrated scenario, user 130 may desire to use terminal 120 with any available network via a suitable transceiver. User 130 refers to service advisor 110 after manual or automatic activation of service advisor 110. Automatic activation may follow from reception by service advisor 110 of sufficient radio communication or operative power (e.g., solar or RF energy). Service advisor 110 receives communication (e.g., radio or optical) from terminal 112, transceiver 106, transceiver 108, and transceiver 126. Service advisor 110 reports the availability of transceiver 112 (for an ad hoc link), network 102 (via transceivers 106 and 108), and network 122 (via transceiver 126). User 130 may then operate terminal 120 as desired to communicate with any of these available resources.

Service advisor 110 may discover services and report only those terminals, transceivers, access points, and/or networks that are available to user 130 and terminal 120. Availability may be reported in terms of services provided by the available entities and their resources. For example, network 102 may provide access to the World Wide Web, and/or particular subscription sites of the World Wide Web. Network 102, network 122, and/or terminal 112 may include data and peripheral resources (e.g., databases, printers, scanners, conventional telephone, FAX). The report of available services may therefore include the identity and/or description of the services of particular web sites and the identity and/or functions of particular data and peripheral resources. The report may include respective relative signal quality and/or estimated available capacity (e.g., signal strength, error rates, or congestion).

In one implementation, service advisor 110 receives communication consistent with IEEE 802.11, transceivers 104 are access points, and terminal 112 is a PC (e.g., a personal computer, workstation, laptop computer, or personal digital assistant). Networks 102 and/or 122 may be a WLAN. By contrast, terminal 120, which is not coupled to service advisor 110 in any way, may be any communication device. For instance, terminal 120 may be a cellular telephone and network 122 may be a conventional cellular telephone network. Service advisor 110 may report that a desired cellular transceiver 126 is available (e.g., providing desired services perhaps different from transceiver 128). Service advisor 110 may further report that voice over Internet (e.g., VoIP) telephony is available via transceivers 106 and 108, prompting user 120 to consider alternate forms of communication from terminal 120. The information provided by service advisor 110 may facilitate use of terminal 120 on either or both of networks 102 and 122.

Terminal 120 may be turned off or put in a low power mode of operation until a suitable report is provided by service advisor 110. As discussed below, because service advisor 110 is functionally simpler than terminal 120, operation of service advisor 110 instead of terminal 120 for the discovery of available services brings about a conservation of power (e.g., the sum of power used by service advisor 110 and terminal 120) and a reduction in radio transmission (e.g., because discovery may be accomplished without transmitting by service advisor 110).

A service advisor, according to various aspects of the present invention, consists of a receive-only communication device. In one implementation, service advisor 110 receives communication in a channel of interest; and determines that the communication is consistent with predetermined characteristics (e.g., is probably not noise, or is consistent with a desired protocol). Service advisor 110 may analyze packets of the received communication to determine the identity of transceivers, networks, and terminals. For instance, service advisor 110 may discover and report the NetId and/or BSSId of an access point. Still further, service advisor 110 may compare discovered NetIds and BSSIds with predetermined NetIds and BSSIds of interest to user 130 and report only those of interest. Interest may be indicated in particular NetIds and BSSIds and/or in ranges of NetIds and BSSIds (e.g., formed with conventional regular expression syntax).

Reporting as discussed above may be accomplished with any conventional annunciator. For example, any conventional vibratory, audio, or display annunciator may be used. Annunciation by the annunciator may include any conventional technique including coded vibrations, music, synthesized voice, coded illuminations, text (e.g., 16 character NetIds), and graphic images (e.g., for signal strength or congestion indications). Annunciations may be obtained from memory of service advisor 110, or in accordance with received communication (e.g., an announcement from the originator of the received communication).

A service advisor may perform discovery passively, that is with little or no transmitting. For instance, service advisor 110 may avoid conventional prohibitions on operation of radio transmitters when service advisor 110 does not include a radio transmitter. Receiving may include signal quality measurement (e.g., provide a received signal strength indicator); and may include reporting (e.g., transmitting) measurements for discovery of a suitable handover destination. Receiving may include a measurement of channel congestion (e.g., provide a channel utilization and/or an average error rate). Error rates may be observed in received communication of other links (e.g., snooping), or by transmitting and receiving for test purposes.

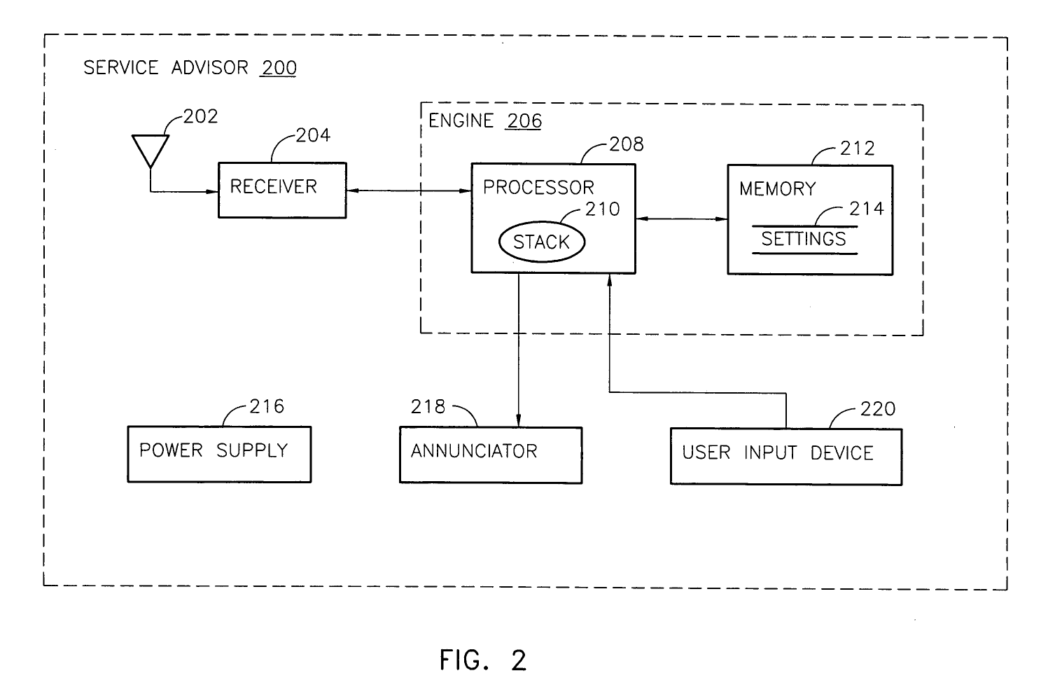

Service advisor 110 may be incorporated into any conventional object (e.g., a key chain or pen) or consumer electronics product (e.g., a garage door opener or watch). Alternatively, service advisor 110 may be implemented as a stand alone apparatus as in FIG. 2. Service advisor 200 of FIG. 2 includes antenna 202, receiver 204, engine 206, power supply 216, annunciator 218, and user input device 220. Engine 206 includes processor 208 performing a communication stack 210; and includes memory 212 storing settings 214. Conventional technologies for ISM communication may be used. As shown, antenna 202, receiver 204, power supply 216, annunciator 218, and user input device 220 are implemented using conventional structures and assembly technologies. In accordance with various aspects of the present invention, engine 206 may include a relatively low-power processing circuit having processing and memory capabilities customized for use in service advisor 200. In other words, lower power and smaller, less expensive service advisors may be constructed with engines having a subset of the types of conventional communication capabilities of somewhat similar engines in other consumer electronics products. For example, although a conventional wireless PDA includes an engine capable of performing a complete protocol stack for analyzing all packet formats defined for the WLAN it cooperates with, engine 206 is implemented with a protocol stack for analyzing a small subset of the packet formats defined for the same WLAN (e.g., only IEEE 802.11 beacon and probe packets in a preferred implementation).

Settings 214 may describe a scope for receiving, detecting, and discovering as discussed above. For example, settings 214 may identify only one service provider or one type of service provider to be reported. This limited form of service advisor may be suitable for distribution by or for the identified service provider to distinguish itself from competition. In another implementation, settings 214 includes any number of parameter values for specifying how receiver 204 and processor 208 cooperate (e.g., channels to be scanned, scan sequence and timing, thresholds for acceptable signal strength, protocols, packet formats, service provider identities, and/or decryption keys).

Power supply 216 may include a battery and/or energy conversion circuitry for solar, optical, or radio frequency energy. Power supply 216 may include one or more switches operable by the user and/or a timer for automatic operation (e.g., auto shut down after inactivity or discovery, periodic operation).

User input device 220 may include one or more switches and may further be arranged to cooperate with a display of annunciator 218. User input device may be operable to specify any values for determining settings 214 (e.g., by menu selections).

The user may provide input via device 220 to instruct the service advisor to perform continuous scanning (e.g., while the user is within the perimeter of an airport). The user may also configure the service advisor to scan for an AP that belongs to an operator to which the user is subscribed. The user may also instruct the service advisor to measure the signal quality of received WLAN communication. While using a WLAN device other than the service advisor, the user may desire to be advised of further detection and/or discovery by the service advisor. For example, the user may desire that the service advisor scan for other APs or channels, in case better quality channels become available.

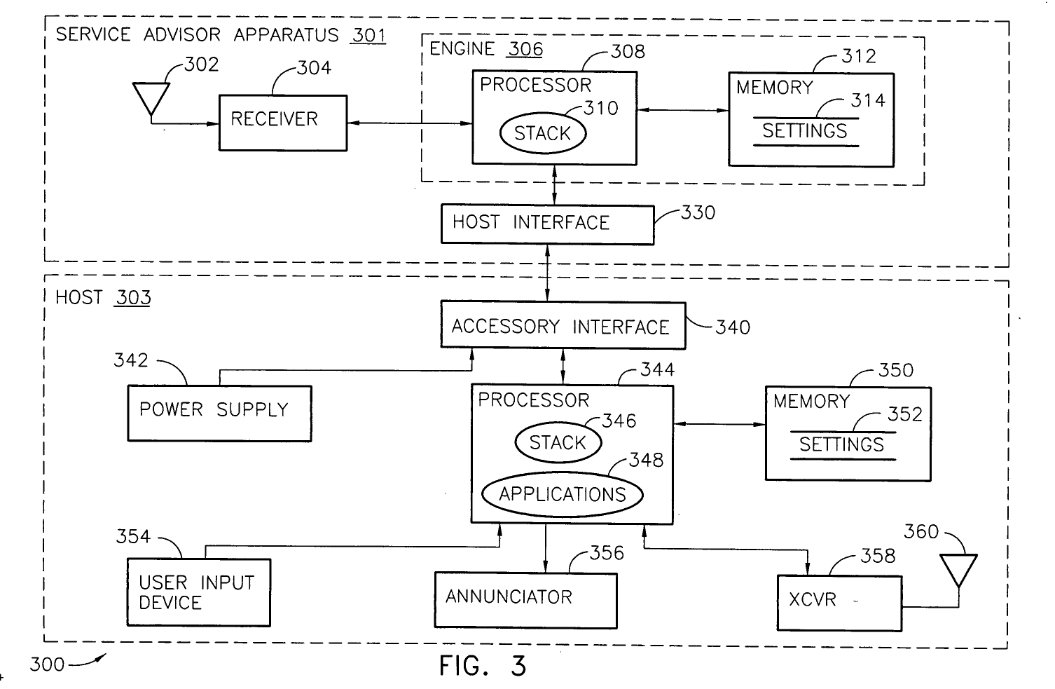

In a second implementation, service advisor 110 is implemented for use in combination with a host (e.g., any conventional consumer electronics product). The host provides power, annunciation, and user inputs; so that these functions may be omitted from the service advisor apparatus. For example, service advisor 300 of FIG. 3 includes service advisor apparatus 301 coupled to host 303. Service advisor apparatus 302 includes the following functional units having structure and functions corresponding to components described above: antenna 302 (202), receiver 304 (204), engine 306 (206), processor 308 (208), stack 310 (210), memory 312 (212), and settings 314 (214). Service advisor apparatus 302 further includes host interface 330 having any conventional structure and circuitry for compatibility with a conventional interface of host 303. Host interface 330 receives power for operation of service advisor apparatus, may include power control switches as discussed above, receives signals responsive to user inputs from host 303, and provides signals for operation of an annunciator of host 303.

Host 303 includes accessory interface 340, power supply 342, processor 344 that performs communication stack 346 and applications 348, memory 350 having settings 352, user input device 354, annunciator 356, transceiver 358, and antenna 360. In one implementation, host 303 comprises a conventional cellular telephone. In another implementation, host 303 comprises a WLAN capable PDA. In yet another implementation, host 303 comprises a pocket watch and transceiver 358 and antenna 360 are omitted. In still another implementation, host 303 comprises a general purpose computer (e.g., laptop computer) or peripheral (e.g., a printer).

In each implementation, host interface 330 of service advisor apparatus 301 is designed to be coupled to an accessory interface 340. Coupling may be as a tap or wye so that any conventional accessory designed for use with accessory interface 340 may be used simultaneously with coupling of service advisor apparatus 301 to host 303.

Settings 352 may be read by apparatus 301 to replace, modify, or supplement settings 314.

Access to and operation of host functions by service advisor apparatus 301 may be according to any conventional technique. In one implementation, serial signaling is used. Commands on the serial interface may conform to well known AT commands.

In addition to annunciation functions discussed above, service advisor apparatus 301 may issue commands to activate and/or control power supply 342 and/or transceiver 358. For example, after detection and/or discovery of a suitable service, apparatus 301 may activate power supply 342 to bring host 303 out of an off condition or a low power mode of operation (e.g., enabling full power operations because an available service has been discovered). In another example, after detection and/or discovery of a suitable service, apparatus 301 may activate or enable operation of at least a transmitter function of transceiver 358. Transmitting may be in accordance with stack 346 to confirm detection, discovery, or to conduct further detection and/or discovery of desired services.

In one implementation of cooperation of system 300, apparatus 301 continues to receive communications, detect, and discover available services; and report findings to host 303. In so doing, processor 346 may operate transceiver 358 to discontinue a first service and activate a second service in response to reporting (e.g., annunciation or control) by apparatus 301. For instance, terminating a cellular telephone call and initiating a VoIP telephone call may be initiated in response to such reporting that indicates a VoIP service has become available.

Stack 310 may be a subset of the capabilities of stack 346. Alternatively, stack 310 may operate on one network or protocol and stack 303 operate independently on another network or protocol. In this latter case, apparatus 301 performs an advisory function unrelated to operation of transceiver 358. For instance, if host 303 comprises a cellular telephone, apparatus 301 may temporarily use annunciator 356 to advise the user of WLAN services so that the user may operate a device (e.g., a PDA or laptop having WLAN capability) unrelated to the cellular telephone utilization.

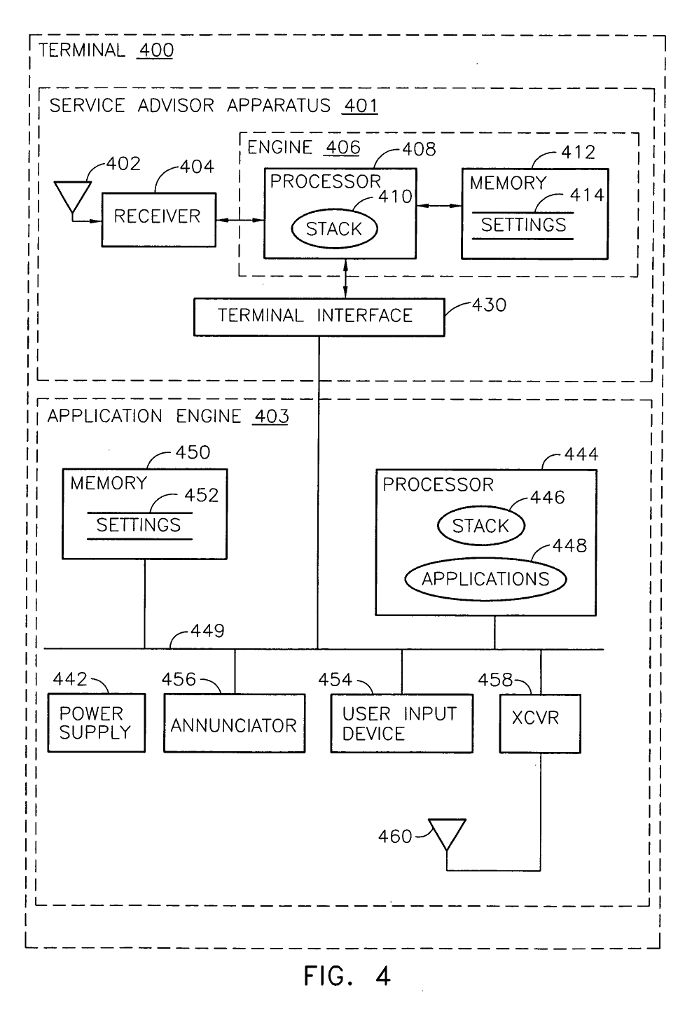

In a third implementation of a service advisor, the functions of a service advisor apparatus as discussed above are integrated with a terminal (e.g., any conventional consumer electronics product). The terminal provides power, annunciation, and user inputs; so that these functions may be omitted from the service advisor apparatus. For example, terminal 400 comprises a service advisor. Service advisor 400 of FIG. 4 includes service advisor apparatus 401 coupled to application engine 403. Service advisor apparatus 402 includes the following functional units having structure and functions corresponding to components described above: antenna 402 (302), receiver 404 (304), engine 406 (306), processor 408 (308), stack 410 (310), memory 412 (312), and settings 414 (314). Service advisor apparatus 402 further includes terminal interface 430 having any conventional structure and circuitry for compatibility with a conventional bus 449 of terminal 400.

Application engine 403 includes the following functional units having structure and functions corresponding to components discussed above: power supply 442 (342), processor 444 (344), stack 446 (346), applications 448 (348), memory 450 (350), settings 452 (352), user input device 454 (354), annunciator 456 (356), transceiver 458 (358), and antenna 460 (360). Application engine 403 further includes a conventional bus for coupling all functional components of the engine to the processor for program control.

When a service advisor (200, 300, 400) analyzes a packet over a WLAN channel that contains a IEEE 802.11 service set identifier (SSID), the service advisor may compare the SSID to one or more stored SSIDs to which the service advisor has access. Stored SSIDs may be included in settings as discussed above (e.g., any or all of 214, 314, 352 (e.g., an address book for an application 348), 414, and 452 (e.g., an address book for application 448)). If the comparison is successful (e.g., an exact or suitably close match), the service advisor may provide notice, provide reporting, or issue controls as discussed above.

A service advisor preferably does not include transmitter functionality. A preferred implementation, consists of a receiver and a processor that implements only a subset of a WLAN MAC (Media Access Control) protocol analysis. The receiver may comprise RF analog and digital circuitry (e.g., an RX-chain) and baseband (BB) logic. Furthermore, the RX-chain, BB layer, and MAC layer may be functionally optimized for identifying MAC packets of a limited number of particular types (e.g., IEEE 802.11 beacon and probe types). Optimization reduces the MAC layer to a fraction of the conventional MAC layer of a consumer electronics product having a communication device (e.g., host stack 346 or terminal stack 446). The service advisor may be designed for the limited purpose of identifying the subset of packet formats and ignore or discard others. Consequently, processing capability and memory capability for a service advisor are relatively less expensive than comparable functions in a host or terminal. Lower data rates simplify the RX-chain. Fewer error control functions typically apply to this subset of packet formats; consequently, BB logic is simplified. The user inputs discussed above may originate from a human user or from a process. Inputs may instruct the service advisor to start scanning for transmitters, to stop scanning, to perform periodic scanning under given values (e.g. scan every minute for 5 seconds and then rest).

Communication between service advisor apparatus 301, 401 and host 303 or application engine 403 may include serial commands of the type specified in the GSM 07.07 standard (e.g., well known AT commands) or equivalent for other standards. AT commands enable the service advisor apparatus to exercise control over the annunciator (e.g., display) and user input device (e.g., keypad) of the host or application engine. To this end, these AT commands might be used: Display control +CDIS, and Keypad control +CKPD.

Service advisor apparatus 301, 401 allows the user to store NetIDs of public WLAN operators to which the user is subscribed. To this end, service advisor apparatus 301, 401 may be configured to use a phonebook of the type stored on a conventional cellular phone. In this case, service advisor apparatus 301, 401 may use AT commands: +CPBR, +CPBF and +CPBW to read, find from, and write into the phonebook respectively.

A service advisor may be implemented with a set of integrated circuits (e.g., a chip set), assembled on a circuit board, and programmed with the MAC and annunciation logic functions discussed above. For example, service advisor apparatus 301, 401 may be responsive to an IEEE 802.11 command known as a MAC layer management function MLME-SCAN.request issued by host 303 or application engine 403 to initiate scanning for suitable SSIDs. The chip-set may include a radio chip (RF), a baseband and MAC chip, and a microprocessor (e.g., a standard rather than a custom processor, a low-power microcontroller preferred) that cooperate to implement service advising based on-one or more standard protocols. The board may further include interface circuitry as discussed above (e.g., a serial or bus interface).

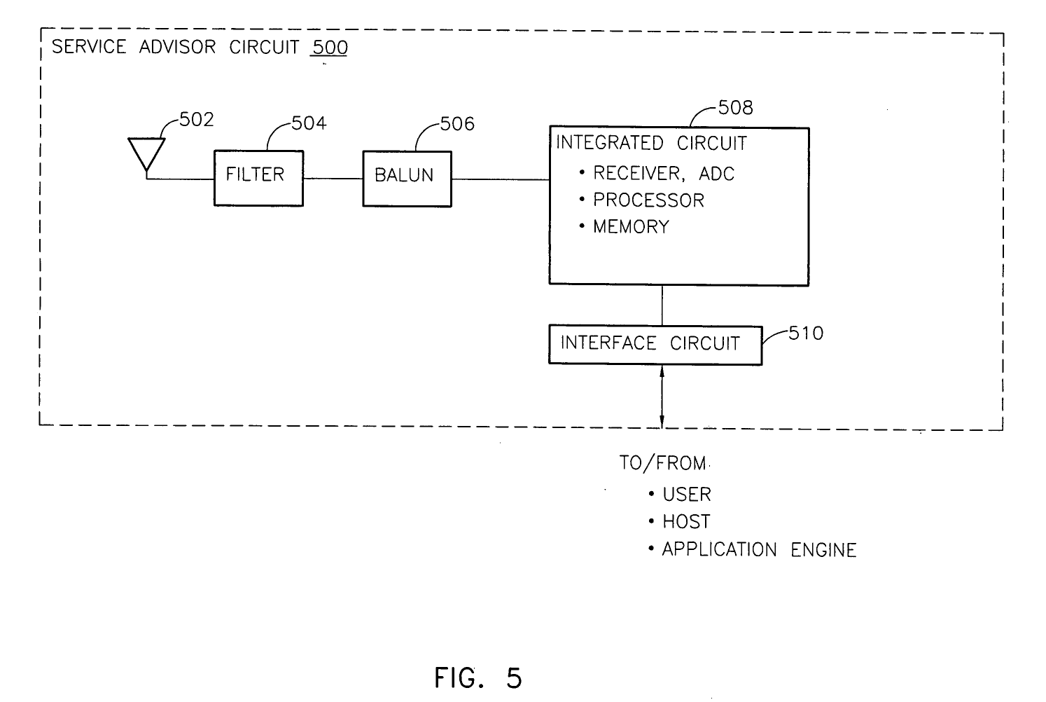

As discussed above, an integrated circuit substrate may be used to implement many functions of the service advisor 200, 300, 400 or service advisor apparatus 301, 401. For example, service advisor circuit 500 of FIG. 5 includes a scanner integrated circuit that implements functions of a receiver and an engine as discussed above. Circuit 500 includes antenna 502, filter 504, balun 506, scanner integrated circuit 508, and interface circuit 510. Circuit 500 may be assembled on a circuit board as discussed above.

Scanner integrated circuit 508 includes receiver analog and digital circuitry, an analog to digital converter (ADC) for converting received analog communication to digital for further analysis, a processor circuit (e.g., corresponding to processor 208, 308, 408), and a memory circuit (e.g., corresponding to memory 212, 312, 412). Memory may include conventional flash memory. Flash memory may store settings 214, 314, 414 including NetIDs as discussed above.

Interface circuit 510 supports the interface functions described above for one or more of the interface to the user (e.g., 110 to 130), to host 303, and to application engine 403. A multipurpose interface may provide greater economies of scale.

The Service advisor circuit 500 or integrated circuit 508 may also automatically find the NetID of the AP if the user is subscribed to an operator running both the GSM (or other cellular standard) and the WLAN network. This scenario is likely because many cellular operators may also run public WLANs. The Service advisor circuit 500 or integrated circuit 508 in this case extracts the NetID from IMSI (International Mobile Subscriber Identity) stored in the SIM card. The AT command +CIMI is used to retrieve IMSI. If the ScannerPlugIn is configured with the NetID, it will, as it is plugged in, only discover APs having that NetID.

One example architecture for the ScannerPlugIn is shown in FIG. 5. The balun is an RF component that converts single ended signals from the antenna to fully differential signals for the radio receiver. It may be used as a separate (off chip) component as it is available from many suppliers, e.g. Murata, for the frequency ranges of interest to us, e.g. 2.4 GHz and 5 GHz ISM and UNII bands. The balun may also be fully integrated on chip in our solution. The crystal oscillator is a component used to provide a stable and very accurate reference frequency to the frequency synthesizer in the radio chip. The frequency of the crystal is determined by the frequency plan and the radio architecture adopted in the design of the radio chip. Our design could use a 20 MHz crystal oscillator device. Such a device is available from many suppliers of the market.

The service advisor may provide a smooth shift from AP-based communication to point-to-point communication. For example, if a PC and a dual-transceiver printer communicate via a WLAN AP, a service advisor may discover a point-to-point link is available from the user's terminal to the printer. The user may then shift to that link if reported quality is acceptable.

In one implementation, a service advisor extracts the SSID (Service Set ID) from a format of received communication (e.g., from a received beacon frame) and displays the SSID (or related information) to the user as a NetID (or service description).

Service advisor circuit 500 or integrated circuit 508 normally discovers all APs by listening on the different WLAN channels. However, it may be configured to discover APs serving a particular NetID. During the scanning process, if the SSID of the AP matches the pre-configured NetID, the user may be notified. Service advisor circuit 500 or integrated circuit 508 contains a very small flash memory enabling the user to easily configure the NetID(s) of interest. Configuration of the NetID may also be done during production of appliances that embed Service advisor circuit 500 or integrated circuit 508. Service advisor circuit 500 or integrated circuit 508 may also measure the signal quality of the WLAN medium. This feature enables users to identify optimum location for their WLAN Stations.

Service advisor circuit 500 or integrated circuit 508 implements the receiver chain of both the RF and IEEE 802.11 baseband as well as a small portion of the standard MAC. Only receiver components are required for the external front-end RF e.g., Balun and BandPass Filter (BPF). Neither antenna switch nor Power Amplifier (PA) is required. Furthermore, no WIFI device certification is needed, as Service advisor circuit 500 or integrated circuit 508 is passive. The baseband implements the receiver chain of IEEE 802.11g that consists of OFDM RX chain and CCK RX chain.

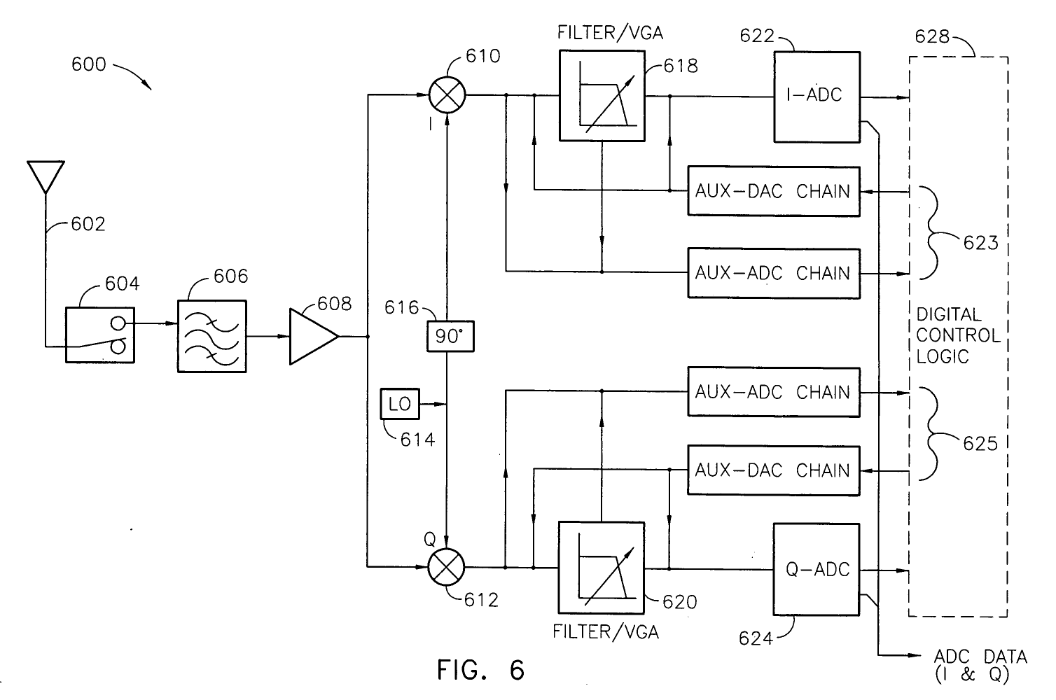

A receiver, according to various aspects of the present invention does not include one or more of channel equalization, full soft decision Viterbi for forward error correction, and intermediate frequency (IF) circuitry. These simplifications are consistent with processing only beacon and probe packets (e.g., lower base rate set). For example, a zero-IF offset cancellation receiver circuit 600 (also called a baseband (BB) circuit) of FIG. 6 includes antenna 602, antenna switch 604, band pass filter 606, low noise amplifier 608, mixers 610 and 612, local oscillator 614, 90-degree phase shifter 616, filter and/or variable gain amplifiers 618 and 620, analog to digital converters 622 and 624, and digital control logic 628 providing digital feedback controls for ADCs 622 and 624 with circuits 623 and 625. By operation of mixers 610 and 612, I and Q phased signals are provided without intermediate frequency (IF) processing circuits. Receiver circuit 600 may further provide a received signal strength indicator signal (RSSI) in any conventional manner (not shown). Antenna switch 604 may be used for initialization of receiver circuits (e.g. with no signal input) or may be omitted.

After conversion of received signals to digital format, digital control logic, firmware, and software (e.g., implemented in an engine 206, 306, 406) cooperate with receiver circuit 600 to accomplish detecting, analyzing packet formats, discovering APs and ad hoc terminals, and reporting as discussed above. For example, digital receiver 700 operates in one implementation as part of receiver 204, 304, 404; and in another implementation as part of engine 206, 306, 406. In either case, signal processing may be accomplished with any mix of special purpose circuits (e.g., having the same functional names) and general purpose circuits (e.g., logic and stored program controllers). Received communication (RX) in digital form is processed by a received communication digital filter (RX Dig. filter), is subject to automatic gain control (AGC), fast Fourier transformation (FFT), decision feedback equalization (DFE), and cyclic redundancy checking (CRC) prior to analysis of frame contents by the physical layer software and MAC layer protocol analyzer. Digital receiver 700 may be implemented with conventional software and circuitry (e.g., an 8-bit microcontroller).

According to various aspects of the present invention, a service advisor 200, 300, service advisor apparatus 301, 401, service advisor circuit 500, or integrated circuit 508 may discover services that use any of several horizontal and/or vertical access technologies. Further, a service advisor may facilitate vertical and/or horizontal handover for a terminal to which the service advisor is coupled. The service advisor may be attached as an accessory to the terminal or integral to the terminal for communication between the terminal and the service provider.

Handover is conventionally preceded by measurements taken typically by the terminal (e.g., also called a mobile station). For GSM, CDMA and UMTS networks, the mobile station typically takes measurements (e.g., of received signal strength) from signals received from its serving cell and signals received from neighboring cells. These measurements are then reported to the serving cell (e.g., on an event driven or regular basis). The network (e.g., the serving cell) may decide whether handover is desired or not. The network then coordinates and performs the handover procedure. For WLANs, the mobile station typically makes the measurements, determines whether handover is desired, and coordinates and performs the handover procedure.

Conducting measurements is problematic particularly for radio technologies operating in continuous transmit/receive mode (e.g., WLAN, CDMA and WCDMA-FDD). For instance, all the radio frames of dedicated physical channels in WCDMA-FDD must be filled. Therefore, it is difficult for the mobile station to use its transceiver (e.g., 458) to take measurements on other radio technologies (e.g., UTRA carriers) at the same time as receiving and transmitting on the current carrier.

According to various aspects of the present invention, a terminal operating on a current access technology (e.g., a current channel) cooperates with a service advisor operating on any of several different access technologies (e.g., different channels of the same of different access technologies). The terminal may rely on measurements, taken by the service advisor, for coordinating handover. The service advisor may take measurements using a wide-band receiver, configured, in turn, for each radio technology suitable for the handover. The terminal transceiver may engage compressed mode to create idle gaps in transmission on the current channel, using any conventional technique, to facilitate measurements performed in the gap by the service advisor. For example, conventional puncturing, spreading factor reduction, and scheduling using restrictions on transport format combinations used in a frame may be used to create gaps in transmissions on the current channel. The service advisor may determine that a handover is desirable and so indicate to the terminal.

A terminal may also cooperate with a service advisor to accomplish handover in less time than taken with conventional techniques. For example, at any suitable time (e.g., after a link-layer handover), the terminal may issue a solicitation for conventional agent advertisements. Agent advertisements may be received (and suitable services discovered) sooner than by awaiting the first unsolicited advertisement in each desired radio access technology. In this way, delays associated with conventional movement detection are reduced or eliminated.

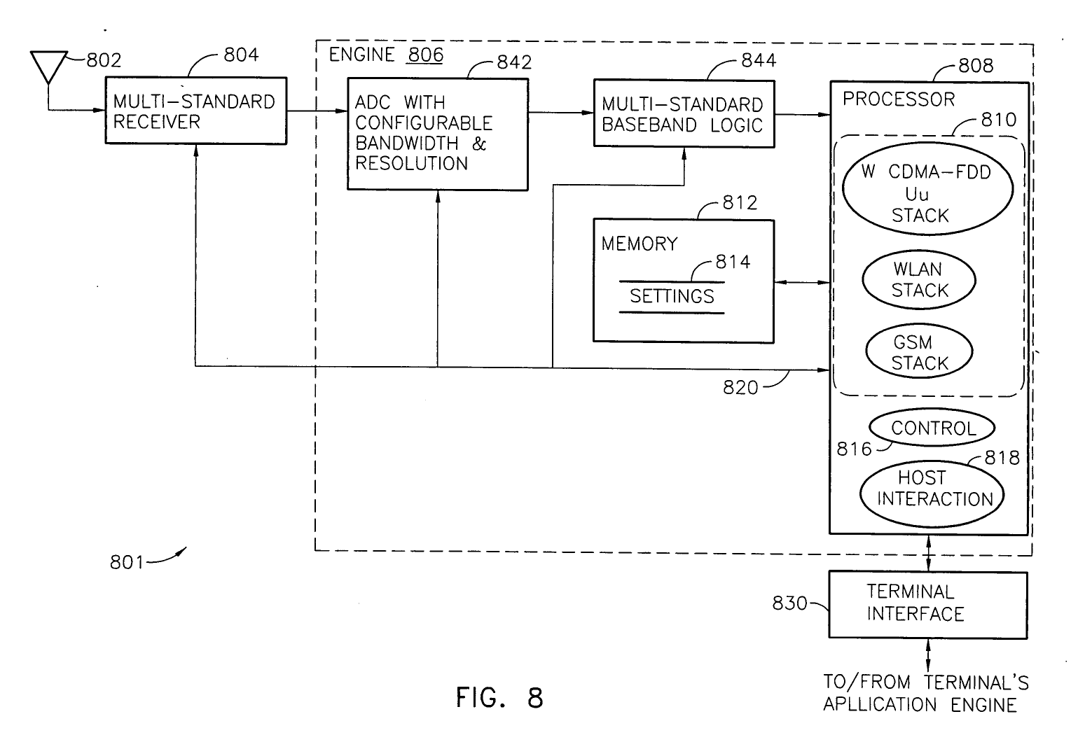

In an exemplary implementation, service advisor apparatus 801 of FIG. 8 discovers services using any of several horizontal and/or vertical access technologies and facilitates vertical and/or horizontal handover as discussed above. Functions of service advisor apparatus 801 will be discussed with reference to its use in place of service advisor apparatus 401 of FIG. 4 to provide an improved terminal. In such an improved terminal, transceiver 458 and processor 444 may operate in parallel with operations performed by service apparatus 801. Processors 444 and 808 may communicate in any conventional manner to suitably share resources (e.g., air time, bus 449 traffic, power from supply 442) and avoid inefficient operation of either processor.

Service advisor apparatus 801 includes antenna 802 suitable (in turn) for each access technology, multi-standard receiver 804, engine 806, and terminal interface 830. Engine 806 includes analog to digital converter 842, multi-standard baseband logic 844, memory 812 having settings 814, and processor 808 having plural stacks 810, control process 816, and host interaction process 818. Processor 808 controls receiver 804, ADC 842, BB logic 844 via control bus 820. A conventional microcontroller may be used for processor 808.

Engine 806 may employ layered re-entrant software and configurable circuitry to receive and analyze communication from plural access technologies with a minimum of special purpose software and circuitry. For example, software may be implemented with components having interfaces between the components, object-oriented design, and responsibility for processing functions arranged in layers between interfaces.

Stacks 810 may include any number of processes for any number of access technologies. In the illustrated implementation, stacks 810 include a process for a WCDMA-FDD Uu stack, a process for a WLAN stack, and a process for a GSM stack. Conventional software technology may be used to implement each stack. When BB logic 844 is providing received communication from a first access technology (e.g., WLAN) results of BB logic may be stored in a suitable queue for the WLAN stack. Queues may supply each process with information from BB logic 844 and processor 808 may be analyzing received communication using multi-threaded processes so that discovery with respect to any access technology may be made (and prioritized) according to availability of processing resources.

Receiver 804 may include the functions and structures of receiver circuit 600 and digital receiver 700 as discussed above and adapted using conventional control circuits for operation on each access technology as directed by processor 808. Band pass filters (e.g., 504) and baluns (e.g., 506) for each access technology may be integrated onto the substrate of a service advisor apparatus. In an alternate implementation, antenna 802 may be co-packaged with front-end components not suitable for packaging with a single chip integrated circuit implementation of apparatus 801. In another alternate implementation the antenna used by the terminal's application engine may be coupled for use by the service advisor apparatus.

Settings 814 may include a set of settings for each of several predetermined configurations.

In operation, control process 816 may perform a loop. In each iteration, process 815 recalls a suitable set of settings 814 from memory 812; assures that the set of settings is properly invoked on the configurable circuits of antenna 802, receiver 804, ADC 842, and BB logic 844; and couples a suitable stack 810 to BB logic 844 for service discovery and/or measurements. Results from each stack may be queued for reporting to the terminal through host interaction process 818.

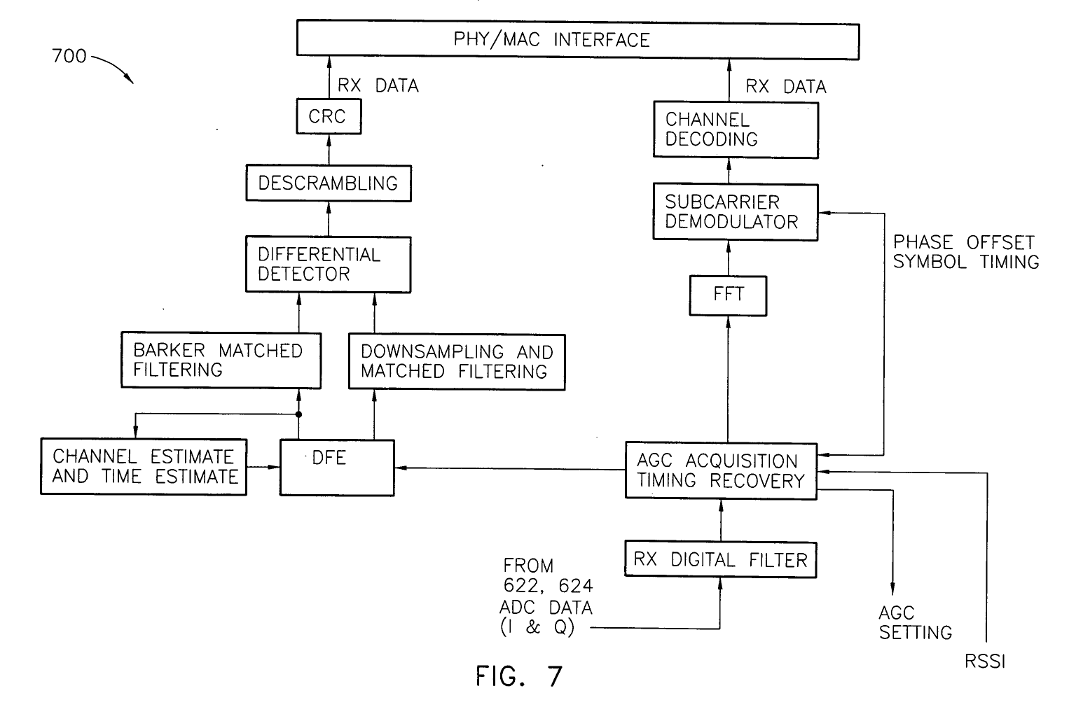

Host interaction process 818 may report services discovered by each stack as discussed above with reference to other service advisor implementations (e.g., FIGS. 2-7). Host interaction process 818 cooperates with terminal interface 830 to provide communication between engine 806 and the terminal's application engine (not shown). Any conventional interface may be used including an interface as discussed above with reference to interface 430. Service advisor apparatus 801 may communicate with the terminal's application engine using a low rate serial interface (e.g., a conventional Universal Asynchronous Receiver Transmitter (UART)).

Service advisor apparatus 801 may be implemented in a service advisor circuit of the type described with reference to circuit 500. Consequently, the multiple access technology functions of service advisor apparatus 801 may be incorporated into any service advisor discussed herein. Annunciations for each access technology may have a respective common form (e.g., text, tones, graphics, narration of speech). For example, a woman's voice may be used to announce all discovered cellular telephone services and a man's voice may be used to announce all discovered wireless network services (e.g., VoIP).

Particular handovers may be performed as authorized by input from the user. User input may be stored as preferred settings. In this way, nuisance handovers may be avoided and handovers from low quality inexpensive services to more expensive services may be avoided in circumstances as desired by the user.

In operation, service advisor apparatus 801 may provide information describing discovered services in a manner suitable for handover decision making by the terminal's application engine. Such information may be provided as requested by the terminal's application engine; and may be selected and/or ordered. Ordering may be based on any combination of identity of service operators, signal quality (e.g., “best”, lowest error rate, least congested), service type (e.g., protocol, access technology). Selection may be based on any logical combination of preferred access technology, preferred operator, preferred signal quality, minimum required service (e.g., bandwidth, capacity, error rate, effective data rate). Examples of such information are described in Table 1. The signal quality for each access technology may be based on physical layer measurements and on criteria specified by the associated access technology standards. The mobile operator may be identified by PLMN Identity in case of UMTS and GSM or Net Identity in case of WLAN.

TABLE 1

| Information | Organization |
|---|---|
| Identification of service operators of | Grouped by access technology; |
| discovered services | Ordered by signal quality to identify a “best |
| | service”, “best cell”, and/or “best channel”; |
| | Ordered by signal quality for each available |
| | service, cell, and channel; |
| | For selected set of one or more service |
| | operators and/or selected set of one or more |
| | services; |
| Identification of access technologies of | Grouped by operator; |
| discovered services | Grouped by access technology; |
| | Ordered by signal quality to identify a “best |
| | service”, “best cell”, and/or “best channel”; |
| | Ordered by signal quality for each available |
| | service, cell, and channel; |
| | For selected set of one or more service |
| | operators and/or selected set of one or more |
| | services; |
| Identification of discovered peers | Grouped by access technology; |
| | Ordered by signal quality to identify a “best |
| | service”, “best cell”, and/or “best channel”; |
| | Ordered by signal quality for each available |
| | service, cell, and channel; |
| | For selected set of one or more service |
| | operators and/or selected set of one or more |
| | services; |
| Notice of change in signal quality | Grouped by operator; |
| | Grouped by access technology; |
| | Ordered by signal quality to identify a “best |
| | service”, “best cell”, and/or “best channel”; |
| | Ordered by signal quality for each available |
| | service, cell, and channel; |
| | For selected set of one or more service |
| | operators and/or selected set of one or more |
| | services; |
| Broadcast system information on the current | May include UMTS SIBs (system information |
| access technology or any specified one or set | blocks), GSM system information received on |
| of services, cells, or channels | a broadcast channel (e.g., BCCH), information |
| Status on a cell and/or channel in terms of | from WLAN beacon messages |
| service effectivity, availability, and | May indicate that a cell is available for |
| conditions | service or barred due to high traffic load or |
| | estimated network conditions in case of |
| | WLAN; |
| Available PLMNs in the current wireless | For example, used to support roaming |
| environment with associated access | |
| technologies and signal quality | |
| Parameters suitable for tuning to the found | May include scrambling code and UTRA |
| best cell and/or channel; | carrier in case of UMTS; broadcast carrier for |
| | GSM; and channel number for WLAN; May |
| | include a time offset of the new cell, enabling |
| | the terminal to immediately synchronize to |
| | the new cell; |
| Measurements (raw, or processed) | Data may be filtered on some important |
| | intermediate scanning results. Filtering may |
| | follow thresholds supplied by the terminal or |
| | on a preconfigured standard that defines |
| | thresholds (e.g., specified in the broadcast |
| | system information) |

Service advisor apparatus 801 may perform scanning in two different modes: (a) continuous mode where service advisor apparatus 801 supplies the terminal's application engine with continuous information about best cells, channels, and access technologies in terms of system information, service, signal quality (e.g., network conditions); and (b) one-time scan where service advisor apparatus 801 performs scanning for the best cell and/or access technology only one time upon request.

The terminal's application engine may command service advisor apparatus 801 to operate in continuous low power scanning mode looking for better cells and/or access technologies having better signal quality, suitable network conditions, and/or lower transmission cost, enabling the terminal's application engine in the idle state to do cell and/or channel reselection or together with the network to decide whether to do handover when the terminal's application engine is operating in a connected state. To reduce battery power consumption by the terminal, continuous scanning may run periodically at time intervals. Different time intervals may be defined based on supported service and power utilization requirements. The terminal's application engine may dictate the power level (e.g., low, medium, or high) and service advisor apparatus 801 may calculate suitable scanning time intervals accordingly. When in the idle state, low power scanning is preferred. However, in the connected state with an established voice session, the high power mode is preferred.

Service advisor apparatus 801 may conduct prioritized scanning where the terminal's application engine may dictate, based on requested service (e.g., packet switched, or circuit switched), the order of the access technologies to be scanned; or the order of parts of a frequency band to be scanned. The terminal's application engine may also specify the bands of interest, for example, (a) 900, 1800, or 1900 MHz for GSM; (b) 1900 or 2000 MHz for UMTS; and/or (c) the range of WLAN channels on the 2.4 GHz band.

Service advisor apparatus 801 may store PLMNs to be monitored (or PLMNs discovered) and their associated access technologies with allocated carriers (also called service operators). This information is dynamic and may be learned from prior scanning for selected PLMNs or may be based on broadcast system information (e.g., SIB 11 of UMTS) that may specify the neighbor cell list. When the terminal's application engine selects the PLMN and calls service advisor apparatus 801 to scan for best cells or access technologies operated by a specified PLMN, service advisor apparatus 801 may first consult its stored PLMNs (e.g., a database) to find associated access technologies and their carriers so as to scan these access technologies and/or carriers. This technique may speed up the scanning process significantly.

The terminal's application engine may also dictate when the scanning results may be reported. For example, reporting may be after: (a) the end of the whole scanning process; (b) the scanning of each access technology, cell or channel; (c) finding the mobile operator; and/or (d) finding the best access technology, cell, and/or channel. The terminal's application engine may stop service advisor apparatus 801 scanning at any time.

Service advisor apparatus 801 scanning capabilities may assist the terminal's application engine to efficiently and seamlessly conduct scanning and measurements for handover without disturbing existing user's sessions. The handover decision may be made by the terminal's application engine and network as opposed to the service advisor apparatus 801. However, service advisor apparatus 801 may speed up the handover process by reporting requested measurements and parameters for a successful handover.

Service advisor apparatus 801 provides several advantages for various radio access technologies. For 3G, service advisor apparatus 801 scans for the best cell and supplies the terminal's application engine with all the parameters required to tune to that cell. In case of hard handover, it may make the ineffective compressed mode superfluous. For example, service advisor apparatus 801 may conduct inter-frequency and inter-access technology cell search and measurements while the main WCDMA-FDD transceiver transmits and/or receives user data.

Service advisor apparatus 801 may be implemented in 0.18 micron CMOS integrated circuit technology with a power conservation architecture (e.g., as for a suitable integrated circuit of the type described with reference to IC 508). As opposed to an implementation involving a chipset or chipsets for each of several access technologies, the integration of service advisor apparatus 801 on a single substrate provides the following beneficial results: (a) lower power consumption; (b) quicker initialization and warm up; and (c) faster identification of available services. Lower power consumption may be due in part to omission of chip-to-chip communication. Initialization and one-time warm up of a single substrate may be accomplished in about 700 msec. as opposed to warm up of that may be required before each use of each different access technology. Service advisor apparatus 801 may discover services, peers, operators, links, and networks faster because scanning may be limited to stored information about PLMNs and their associated access technologies. For example, the most desirable services, cells, channels, links, networks, peers, and/or operators may be discovered by priority scanning (e.g., trial and error from an ordered list).

Service advisor apparatus 801 may be used for cell to cell handover.

Service advisor apparatus 801 may improve UTRAN performance by making the Immediate Cell Evaluation procedure for Random Access Channel (RACH) possible. In one implementation, the terminal is “camped on” the best cell before sending RACH bursts to UTRAN. Later, the terminal may ramp up the RACH transmission power by an increment for each burst. If the terminal sends bursts to the wrong Node-B that is closer than the serving Node-B, severe interference could be introduced because the RACH burst is addressed to the serving Node-B far away and the received signal power at the nearby Node-B may be high. This could occur if the terminal has moved to a new cell and cell reselection has not been accomplished yet. To avoid this, the terminal may check if it's serving cell is still the best. Immediate Cell Evaluation takes time when the terminal measures the signal quality (e.g., strength) of the neighboring cells and compares these measurements to the signal quality of the serving cell. The neighbor cell list may be included in the system information SIB 11. The procedure may consume even more time when cell reselection is to take-place. Existing 3G terminals do not support this feature and 3GPP has left this issue unsolved. Service advisor apparatus 801 with its continuous cell search on intra-frequency neighboring cells may avoid Immediate Cell Evaluation as discussed herein.

For WLAN, the lengthy channel scanning required for mobility that could take seconds may be skipped and the terminal's application engine may momentarily get all the information required to immediately connect to the new WLAN cell, including channel number, content of various rate sets (basic, supported and operational), supported standard (IEEE 802.11b, or mixed IEEE 802.11b and 11g), QoS support, and type of security supported.

Service advisor apparatus 801 may measure network conditions of WLAN channels using virtual sensing based on monitoring the NAV (Network Access Vector) parameter exchanged in various WLAN frames. Service advisor apparatus 801 may scan for the best WLAN cell (e.g., where “best” herein means having signal quality and/or available capacity exceeding minimum desired thresholds; and/or having channel access delay less than a maximum desired threshold).

Service advisor apparatus 801 may started scanning with non-overlapping sets of channels.

Service advisor apparatus 801 may store discovered Net IDs and their associated channels in a database in any conventional memory device accessible by service advisor apparatus 801. Scanning may be consistent with such a database so as to more quickly discover and report services of interest. Service advisor apparatus 801 by using stored information describing the current and desired environment and PLMNs provides much faster cell search than any standard GSM transceiver. Conducting inter-access technology pre-handover measurements (e.g. for WCDMA) while the mobile terminal's application engine is currently connected via GSM, may require modifications on existing GSM chipsets particularly the timing of the synthesizer because the time required to do cell search on WCDMA is more than the time for doing cell search on other GSM broadcast carriers. While GSM is used for communication, service advisor apparatus 801 may scan the WCDMA medium and receive the latest broadcast system information including any predefined configurations (e.g., as included in SIB 16). The handover process from GSM to UTRAN may be quicker because this information is received in a timely manner and/or is applied to improve scanning.

For mobile IP service advisor apparatus 801 speeds up the movement detection of the Mobile Node by monitoring the condition of the used medium and notifies the Mobile IP layer when significant changes have occurred. Service advisor apparatus 801 may also recommend a better channel than currently available in the wireless environment. The Mobile IP may broadcast an Agent Solicitation message on the new channel forcing available Mobile Agents to respond with Agent Advertisement message. If network prefix of the new Foreign Agent is the same as the network prefix of current Foreign Agent, the Mobile Node may perform handover to the new channel and register with the new Foreign Agent.

In an alternate implementation, service advisor apparatus 801 may also be extended with capability to detect an Agent Advertisement message enabling service advisor apparatus 801 to detect Mobile IP movement without assistance from the terminal's application engine. In one implementation, a “make before break handover” is accomplished.

From the protocol point of view, a service advisor according to various aspects of the present invention includes a multiple stack engine, where each stack may be dedicated to an access technology and contain the functions required for measurements for that technology. For example, each stack may be a set of objects having a common interface to a control process (816) and a host interaction process (818).

In one implementation, service advisor apparatus 801 operates one access technology at a time. By operating only one access technology at a time, most service advisor functional blocks may be shared among the supported access technologies. For instance, the baseband logic for several access technologies may share functional blocks for equalization, error checking, and convolutional decoding. This implementation includes only one configurable ADC and shared analog receiver circuitry (e.g., a common analog baseband circuit). Before such a service advisor apparatus starts scanning one access technology, the parametric variables (e.g., configuration settings) of the circuits that implement the shared functions may be set with values specific to that access technology.

A service advisor apparatus may operate in an idle mode for one or more access technologies. By using idle mode, only a subset of the circuitry for an RX-chain of a terminal of each access technology need be implemented. For example, received information for discovery and measurements for the WCDMA-FDD and GSM access technologies may include idle mode monitoring of system information sent on low rate broadcast channels. The WLAN access technology may be monitored with broadcast channels of 11 Mbps rate. IEEE 802.11b networks typically use 1 or 2 Mbps rate to broadcast beacon messages. RSSI measurements may be taken on broadcast channels. The measurements may be conducted in the receive chain circuitry. A service advisor apparatus may omit power control, ARQ (Automatic Repeat Request) for error control, data security functions, and channel multiplexing in case of WCDMA-FDD. In addition, for WCDMA-FDD and WLAN, a service advisor apparatus may implement only fixed spreading capability.

Unless contrary to physical possibility, the inventor envisions the methods described herein may be performed in any sequence and/or combination. The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

1. A service advisor for providing notice regarding the availability of a wireless communication service, the communication service usable by a provided communication device not coupled to the service advisor, communication being consistent with one or more protocols each having a plurality of packet formats, the service advisor consisting essentially of:
a receiver that receives communication; and
an engine, coupled to the receiver, that recognizes in response to the communication, only a limited set of packet formats of the plurality of formats; that determines, from a packet having a format of the set, indicia of an available service; and that facilitates operation of a provided annunciator to provide notice in accordance with the indicia of available service, wherein the use of the available service by the device involves recognizing by the device a packet format not included in the set.

2. The service advisor of claim 1 further consisting of a user interface having a control for operation by a user, the control for determining a service to be advised of.

3. The service advisor of claim 1 further consisting of a user interface having a control for operation by a user, the control for enabling provision of notice.

4. The service advisor of claim 1 further consisting of a user interface having a control for operation by a user, the control for inhibiting provision of notice.

5. The service advisor of claim 1 further consisting of a user interface having a control for operation by a user, scanning being accomplished at times in accordance with the control.

6. The service advisor of claim 1 further consisting of a user interface having a control for operation by a user, scanning being accomplished on a channel in accordance with the control.

7. The service advisor of claim 1 further consisting of a user interface having a control for operation by a user, the control for specifying a service for which notice is desired.

8. The service advisor of claim 1 wherein notice comprises a plurality of network service identifiers.

9. The service advisor of claim 1 wherein the engine comprises a nonvolatile memory and determining is further limited to services corresponding to data stored in the nonvolatile memory.

10. The service advisor of claim 1 wherein the receiver is implemented on a substrate and the engine is implemented on the substrate.

11. A service advisor for detecting the availability of a wireless communication service, communication being consistent with one or more protocols each having a plurality of packet formats, the service advisor consisting essentially of:
an interface for coupling the service advisor to a provided consumer electronics product, the product comprising an annunciator;
a receiver that receives communication; and
an engine, coupled to the receiver and to the product via the interface, that recognizes in response to the communication, only a limited set of packet formats of the plurality of formats; that determines, from a packet having a format of the set, indicia of an available service; and that facilitates operation of the annunciator in accordance with the indicia of available service, wherein the use of the available service by the product involves recognizing by the product a packet format not included in the set.

12. The service advisor of claim 11 wherein the advisor receives operative power via the interface.

13. The service advisor of claim 11 wherein the provided product comprises a transmitter for use of the available service.

14. The service advisor of claim 11 wherein the provided product comprises a transmitter for disabling communication by a source of the received communication.

15. The service advisor of claim 13 wherein the provided product comprises a circuit that is enabled, in response to the indicia of available service, for increasing power consumed by the product.

16. The service advisor of claim 11 wherein the product comprises a control for operation by a user, the service advisor responsive to operation of the control for determining a service for which the indicia of service is to be provided.

17. The service advisor of claim 11 wherein the product comprises a control for operation by a user, the service advisor responsive to operation of the control for enabling provision of the indicia of available service.

18. The service advisor of claim 11 wherein the product comprises a control for operation by a user, the service advisor responsive to operation of the control for inhibiting provision of the indicia of available service.

19. The service advisor of claim 11 wherein the product comprises a control for operation by a user, the service advisor responsive to operation of the control, scanning being accomplished at times in accordance with the control.

20. The service advisor of claim 11 wherein the product comprises a control for operation by a user, the service advisor responsive to operation of the control, scanning being accomplished on a channel in accordance with the control.

21. The service advisor of claim 11 wherein the product comprises a control for operation by a user, the service advisor responsive to operation of the control for specifying a service for which indicia of available service is desired.

22. The service advisor of claim 11 wherein the indicia of available service comprises a plurality of network service identifiers.

23. The service advisor of claim 11 wherein the product comprises a memory and determining is further limited to services corresponding to data stored in the memory.

24. The service advisor of claim 11 wherein the receiver is implemented on a substrate and the engine is implemented on the substrate.

25. A service advisor for detecting the availability of a wireless communication service, communication being consistent with one or more protocols each having a plurality of packet formats, the service advisor consisting essentially of:
an interface for coupling the service advisor to a provided consumer electronics product, the product comprising a transceiver;
a receiver that receives communication; and
an engine, coupled to the receiver and to the product via the interface, that recognizes in response to the communication, only a limited set of packet formats of the plurality of formats; that determines, from a packet having a format of the set, indicia of an available service; and that facilitates operation of the transceiver in accordance with the indicia of available service, wherein the use of the available service involves recognizing a packet format not included in the set.

26. The service advisor of claim 25 wherein the advisor receives operative power via the interface.

27. The service advisor of claim 25 wherein the provided product comprises a circuit that is enabled, in response to the indicia of available service, for increasing power consumed by the product.

28. The service advisor of claim 25 wherein the product is capable of communicating with each of a plurality of wireless communication services and the engine and receiver cooperate to discover services on each of the plurality of wireless communication services.

29. The service advisor of claim 25 wherein the plurality of communication services includes a wireless local area network service and a telephone service.

30. The service advisor of claim 29 wherein the wireless local area network comprises an IEEE 802.11 protocol.

31. The service advisor of claim 29 wherein the telephone service comprises a GSM protocol.

32. The service advisor of claim 25 wherein the plurality of communication services includes a voice over Internet service.

33. A communication device comprising:
a service advisor that discovers services, the service advisor having a receiver; and
an application engine, coupled to the serviced advisor, that performs at least one of a horizontal and a vertical handover to a discovered service, the application engine comprising a transceiver, wherein the service advisor and the application engine cooperate for operation of the receiver without interfering with the transceiver.

34. The communication device of claim 33 wherein the advisor reports indicia of signal quality to the application engine and the application engine determines whether to perform a handover in accordance with reported signal quality.

35. The communication device of claim 33 wherein the receiver receives communication comprising a packet having indicia of network identification and the service is discovered in accordance with the indicia of network identification.
